(19) United States
(12) Patent Application Publication
(10) Pub. No.: US 2015/0018061 A1
(43) Pub. Date: Jan. 15, 2015

(54) GENERATING AND VERIFYING VALUES USED IN GAMES

(71) Applicant: Joseph Y. Lee, Rancho Palos Verdes, CA (US)

(72) Inventor: Joseph Y. Lee, Rancho Palos Verdes, CA (US)

(21) Appl. No.: 14/329,607

(22) Filed: Jul. 11, 2014

Related U.S. Application Data
(60) Provisional application No. 61/845,382, filed on Jul. 12, 2013.

(51) Int. Cl. G07F 17/32

(52) U.S. Cl. CPC G07F 17/3241; G07F 17/3244; G07F 17/3293
USPC 463/11; 463/25; 463/17; 463/16

(57) ABSTRACT

For a game of chance, a selected game value is generated. The selected game value is used to determine whether the player is a winner or a loser. An historical value for a financial asset used to generate the selected game value is displayed. The historical value is generated after the input receives the game input from the player and before the display displays the selected game value. The historical value is generated by a financial exchange independent of the gaming table. The historical value generated by the financial exchange is verifiable by an internet query to an information server. An amount of detail displayed for the historical value is based on the selection received from the player.

### BACKGROUND

Online gaming websites use random number generators for games such as blackjack, baccarat, poker, roulette and craps. Gaming at these online sites presents risks for players because how it is operated is not easily transparent to the player. It is very difficult to determine the integrity of a particular card, dice, roll, or other typically random result in these games of chance online. Even with information provided, it is often very difficult to verify the integrity of the information.

Many players suspect that online games of chance such as Blackjack are rigged. That is one of the top concerns for players that consider playing blackjack or other online games of chance on the internet, even if it is a human dealer on the internet web site. For example, some players suspect that the cards are dealt in certain patterns so that certain hands will be specifically chosen by the site, resulting in bad losses for other players. Most online poker sites use a RNG (Random Number Generator) to randomly choose cards from a 52 card deck on every singly hand. But it would be virtually impossible to prove to the satisfaction of a suspicious player that the cards were in fact chosen randomly. The authenticity of online games is much more difficult for a player or independent observer to verify.

### BRIEF DESCRIPTION OF THE DRAWINGS

FIG. 1A is a flow chart illustrating a method according to an implementation.

FIG. 1B is a flow chart illustrating a method according to another implementation.

FIG. 2 is a flow chart illustrating a method according to another implementation.

FIG. 3 is a flow chart illustrating a method according to another implementation, especially focusing on time details.

FIG. 4 is a flow chart illustrating a method according to another implementation, for use in roulette.

FIG. 5 is a flow chart illustrating a method according to another implementation, for use in blackjack.

FIG. 6 is a flow chart illustrating a method according to another implementation, for use in craps.

FIG. 7 is a schematic view of a blackjack table and components according to an implementation.

FIG. 8 is a simplified block diagram of hardware utilized in various implementations.

### DETAILED DESCRIPTION

Implementations are disclosed for providing random or almost random number for use in games of chance and then providing almost instant verification of the almost random or random number in a way that the players can be certain that no one has access to the random number. For example, the highly fluctuating smallest digits of financial data such as the S&P 500 Index (Standard & Poor's 500) are used to provide a random or almost random number which is then converted into a card, dice, or wheel (whatever the game of chance may be) using algorithms. The random or almost random number that is generated is posted on a web site so that a player can see the random number and the corresponding card in historical fashion.

Random numbers for games of chance are verifiable almost immediately after the random number is selected, by numerous independent parties. The current implementation can be used for almost all games of chance on the internet or accessed elsewhere. Current online gaming websites that use random number generators include games such as blackjack, baccarat, poker, roulette and craps. Gaming at these online sites presents risks for players because how it is operated is not easily transparent to the player. It is very difficult to determine the integrity of a particular card, dice, roll, or other typically random result in these games of chance online. Even with information provided, it would be almost impossible to verify the integrity of the information.

Many players believe that online games of chance such as Blackjack are rigged. That is one of the top concerns for players that consider playing blackjack or other online games of chance on the internet, even if it is a human dealer on the internet web site. Many people suspect online poker to be fixed or rigged. To clarify, when people say that online poker is rigged or fixed, they believe that the cards are dealt in certain patterns so that certain hands will be specifically chosen by the site, resulting in bad losses for other players. Most online poker sites use a RNG (Random Number Generator) to randomly choose cards from a 52 card deck on every singly hand. But it would be virtually impossible to prove to the satisfaction of a suspicious player that the cards were in fact chosen randomly. The authenticity of online games is much more difficult for a player or independent observer to verify.

In the method of the current implementation, there will be no doubt in the mind of even the most doubting player, that no one knows what card will be dealt prior to the hand being dealt. Because everyone can be assured that the randomness of the card distribution is unknown by anyone in advance and then after the cards are dealt, verifiable by all involved within seconds, there will be acceptance of the “bad beat” without escalation and irate phone calls to the online gaming site. This will result in much less requirement of a customer service call center and the concomitant expensive resources to maintain a large customer service center.

Online poker sites often use a third party or independent organization to determine the adequacy of their random number generators and systems since fairness is a very important part of any online gaming experience.

The method of this implementation can be used to generate random numbers for games of chance on the internet via a website. Current online gambling sites provide random cards in generally the following method. A random number generator (RNG) is used to provide a random number. The random number is input into an algorithm that converts the random number into a card. Random number generators have applications in gambling, statistical sampling, computer simulation and other areas where producing an unpredictable result is desired.

In the method of the current implementation, because the random number is easily verified almost instantly by many possible sources, the timing of the player's interaction with the game becomes very important.

Truly random numbers are the essence of any fair online gaming and independent assessment to confirm the reliability and security of the random number generator is of value to the potential customer. Current online gaming websites use a third-party to assess their hardware and software. The independent third party can confirm that the software meets certain gaming software criteria, but they cannot confirm that each hand is randomly dealt. Even given this type of scrutiny, players can suspect that the web site may not be complying at a later date or that the website did not truly turn over the software that is actually being used by the website. Many levels of trust are still required and there are many ways that the online gaming website could still manipulate results. The third-party testers will analyze the source code and run statistical tests to ensure that the RNG (random number generator) behaves randomly. However, there are still many flaws. For example, in between the testing (possibly years apart), different software can be used. There is no convenient easy way to identify at the time a player is actually playing that the software and random number generator is working fairly.

In the method of the current implementation, the random numbers generated and used in determining the cards that are dealt can be verified almost immediately every time by the player. In the method of the current implementation, the player can verify the random number used in his or her particular game through hundreds of independent sources at the time of play or at a later time, as long as the player knows what day and time he played. This is a transparent system for generating random or almost random numbers for the use in gaming and will win the confidence and trust of players.

The method may also comprise a modular form where the player is sitting near the module and the player is not in a remote location, but nearby, and the game-play action of the player is transmitted to the processor of the module directly, not necessarily using a network.

Random number generators have many applications including gambling, statistical sampling, cryptography, lotteries and computer simulation. The methods of the current implementations have applications in all these fields.

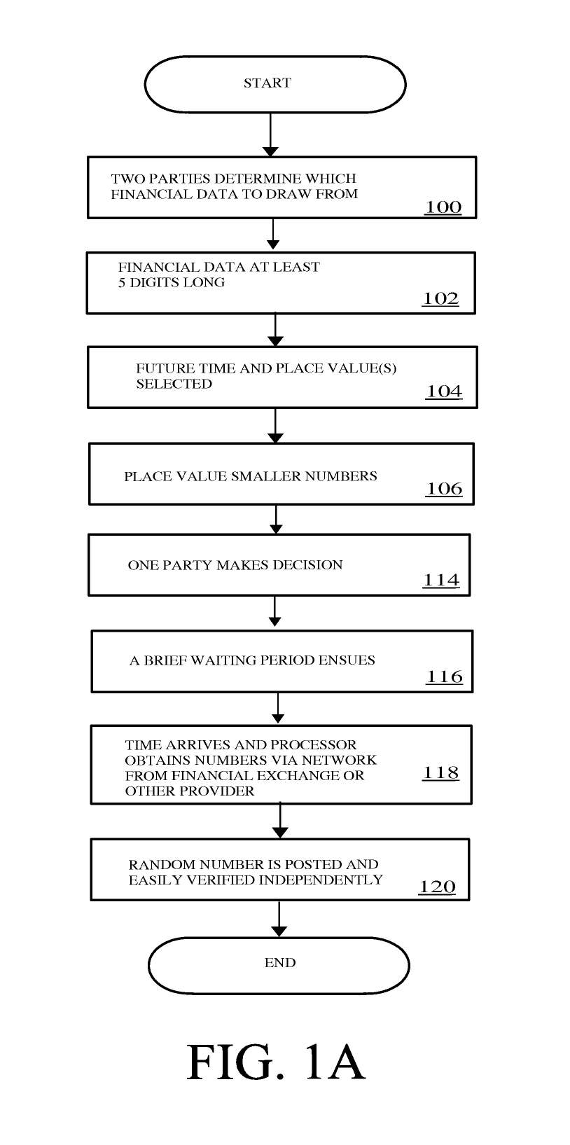

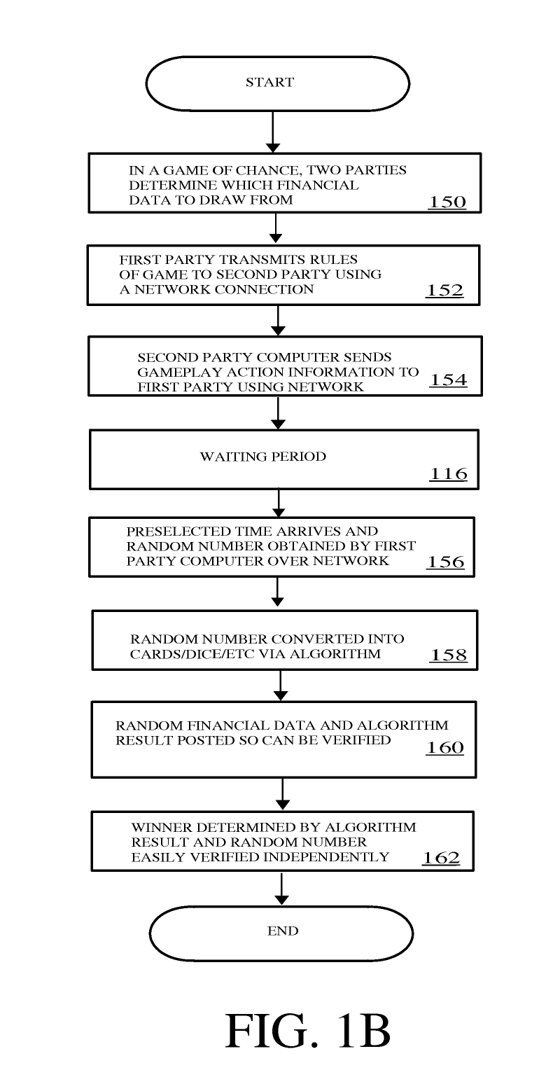

In an example implementation illustrated by FIG. 1A, in block 100 at least two parties agree which financial data to draw random numbers from. For example, financial data is historical values for a financial asset used to generate the selected game value. For example, the historical values are generated after the input receives the game input from the player and before the display displays the selected game value, the historical value being generated by a financial exchange independent of the gaming table. The historical value generated by the financial exchange is verifiable by an internet query to an information server.

In block 102 illustrates using financial data that provides a number that is at least 4 total digits in length but preferably five (5) digits or longer in length. A block 104 illustrates agreeing upon the exact future time from which the financial data number will be collected and agreeing upon the exact place values of the financial data number from which the random number(s) to be extracted will be selected. A selection received from the player indicates which financial asset will be used to generate a selected game value.

A block 106 illustrates confirming that the place value selected must be at least the third position to the right (from the left most number that is not zero). A block 114 illustrates having at least one party make a decision that may be affected favorably or unfavorably by the random number that is selected from the future time. A block 116 illustrates having that one party inform the other party of the decision with both sides agreeing how the random number will result in a favorable or unfavorable outcome based on the decision and having a waiting period between the decision and the extraction of numbers from the financial index. A block 118 illustrates extracting the number(s) from the pre-selected place value(s) of the financial data at the pre-selected time. A block 120 illustrates both sides being able to within seconds (or minutes) verify the random number generated through independent means.

FIG. 1B illustrates an example implementation that provides for online gaming with random data that can be easily verified. A block 150 illustrates setting rules of the game and rules regarding how to select random numbers from a particular financial data number at a particular time in the future, random numbers that cannot be known to the first party (e.g. “house”) or the second party (e.g. “player”). A block 152 illustrates using a network connection to transmit information 152 to a remote player's client computer including information about rules of the game. A block 154 illustrates receiving information over the network connection about a game-play action from the player. A block 156 illustrates using the processor to obtain real time financial data information from a financial exchange (or other provider of real time financial data) via a network connection. A block 158 illustrates using a processor and an algorithm to convert the random portion of this financial data into cards, dice, roulette numbers, etc. A block 158 also illustrates using the processor and memory to process the game-play action using the random data from the financial data provider. A block 160 illustrates transmitting information to the remote player's computer regarding the outcome of the game-play action consistent with rules of the game. A block 162 illustrates transmitting the random numbers acquired from the financial data provider to the player's processor, so the player can easily independently verify the random numbers to be accurate and truthful.

In many gaming situations, a high degree of randomness that is not completely random may be preferred if that random number can be verified easily, especially if neither party knows which side will benefit from the lack of complete randomness. The tenths number position of the S&P 500 Index and the hundredths number position of the S&P 500 Index may approach true randomness but is verifiable by many sources in real time data.

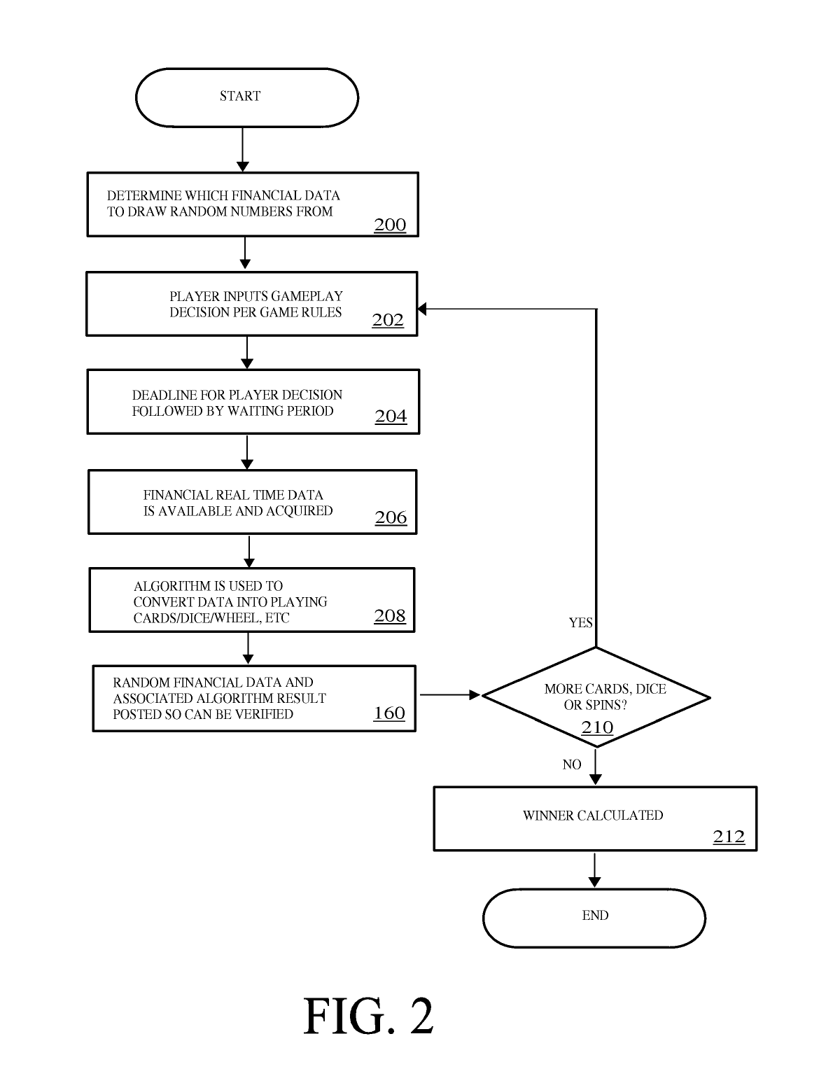

FIG. 2 is a simplified flowchart explaining how the rules of a game to be played are displayed and made easily available. For example, the game of chance will require a random number or an almost random number. For example, the random number will be acquired from financial data.

In a block 200, the description of the financial data number to be used in the game is displayed. For example, the financial data number to be used constantly fluctuates when the market is open. For example, some financial data, such as the S&P 500 index, are published every 15 seconds. The S&P 500 Index, for example, is maintained by Standard & Poor's. It is a stock market index based on the market capitalizations of 500 leading companies that are publicly traded in the U.S. stock market. It is one of the most commonly followed equity indices in the world. Players can be confident that manipulating the tenths and hundreds numbers of this index 15 to 30 seconds before it is disseminated would be impossible.

Rapidly changing financial data that is widely available in real time such as the S&P 500 Index, DJIA and Nasdaq 100 Index are ideal. The larger the number of significant digits (Dow Jones Industrial Average Index has 7 significant digits, e.g. 14,909.60 and the last two digits fluctuate relatively unpredictably), and the more the particular index fluctuates, the more likely the last two digits will be random). Financial indices from Europe and Asia such as the FTSE100, DAX, CAC40, Nikkei 225, Hang Seng, and Straight Times are also ideal because of the liquidity and large size. Individual company stock data may be used if sufficiently large. Mutual fund data, ETF data, bond data, Volume data, commodity data and futures data can also be used. Some markets are closed at some times, but there is usually a financial market somewhere in the world that is open and a corresponding financial index that is fluctuating. A combination of the smallest value digits (e.g., for S&P 500 Index value of 1605.28, the smallest place value number would be the “8” in the hundredths place) from different indices may be used. The tenths place is immediately to the right of the decimal point and in the example 1605.28, the number in the tenths place (TPN) is the “2”. The number in the hundredths place (HPN) in this example 1605.28 is the “8”. The number in the hundredths place would normally be more random than number in the tenths place, given that the market is open and being traded. In contrast, the number in the hundreds place in this example 1605.28 is “6” and would not be very random at all.

Financial data is more readily available in real time in more places than almost any data in the world. Although most people do not believe stock data to be random, the “ones” data, the “tenths” number and the “hundredths” number is fairly random, with the smaller “hundredths” number being much more random than the “ones” number. For example, in the S&P 500 Index data, which is constantly fluctuating during the day, the number may be 14,131.25. At any given minute, the “tenths” number 2 and the “hundredths” number 5 will fluctuate and likely change in a close to random fashion. Although in the current implementation, the “tenths” place number and the “hundredths” place number of the S&P Index is used as the random number provider, any stock Index number such as the DJIA or Nasdaq 100 Index or foreign indices could be used.

Many other variations are possible but based on the premise that the number provided fluctuates readily to be able to provide reasonably almost random numbers at a pace where players can play the game. Currently, among financial data that is readily available, the tenths place and hundredths place are the most random digits. However, the thousandths place (third digit to the right of the decimal point), the fourth digit to the right of the decimal point, the fifth digit to the right of the decimal point, and so on and so on, provide additional random numbers but are not currently easily available in real time. Typically, the digits to the right of the decimal place will be used to provide the random or almost random numbers for the method of this implementation. However, if financial data presents in a form such as 123,456.78, then in this number, beginning with the leftmost nonzero digit (in this case, “1”) and extending to the right, a number that is at least the third position (in this case, “4”) from the leftmost nonzero digit, can also be used, but a number that is at least the fourth position from the leftmost nonzero digit is preferred (in this case, “5”). The numbers that are more to the right than the fourth position from the leftmost nonzero number, can also be used (in this case, “6”, “7”, and “8”). The total digits in this number is eight. For a financial number to be useful, the financial number (index or otherwise) must have at least 4 digits, but more than 5 digits is preferred.

Rarely, different providers of stock data may have slightly different numbers. However, even in those situations, it would be difficult to convince anyone that the stock data provider had an interest in the particular random number generated by the stock data and used in the game between the “house” and the “player”.

Once a financial number thought to be random is generated by the method of this implementation, the output (smaller digits of the financial number as previously described) can undergo testing to see how random the number truly is. There are many such tests available to do this currently. One way to examine the degree of randomness of the output is “Simple visual analysis”. This creates a visualization of the numbers produced by the random number generator (RNG). The visual system of humans is adept at spotting patterns and this method is a fairly quick way of determining how well a given RNG is performing. The visual pattern produced by using www.random.org's bitmap generator will create a much more random picture compared with the bitmap picture formed by the Rand ( ) function on Microsoft Windows which is a pseudo-random number generator (PRNG).

In yet another variation of this method, not illustrated in the drawings but easily appreciated by those of skill in the field, the random numbers provided by the financial indices could be used as the “seed” number for a traditional random number generator. To produce a pseudorandom sequence, all that is needed is the algorithm and an initial “seed” number.

It is with care that the term “significant digits” is avoided because “significant digits” is defined as the digits in a decimal number that are warranted by the accuracy of the means of measurement. If the S&P 500 Index is in the future reported as 1300.4567, then it could be argued that the thousandth's place “6” and the ten-thousandth's place “7” are not significant digits. However, that number would have a total of eight (8) digits in it and still be useful for the method of this implementation, although it would be difficult to prove that the most right two numbers are warranted by the accuracy of the means of measurement.

In a block 202 (shown in FIG. 2) a player makes an input into the game. Online gaming often involves software programs that permit a remote game player to enter bets, wagers and other necessary game-play actions (such as ante, post, call, raise, check-raise, all-in, double-down, split, side bet, insurance, stand/stick, stay, hit, draw, fold, etc). Game-play actions for online games are communicated via an input from the player. The input can be a touch (if using touch-screen), a mouse click, a key-press, or any other input device or method.

There is a time during which a player can make an input into the game. A block 204 illustrates a deadline. The deadline must be sufficiently far from the first “published” or “released” time of the fluctuating financial data. For example, the S&P 500 Index is published every 15 seconds. If data from only the start of every minute is used in this particular example, then the deadline for making a player input into the game would be at least 10 seconds prior to the published time of exactly 11:00:00. This is termed the waiting period illustrated by block 204.

In a block 206 of FIG. 2, financial real time data, once it becomes available, is acquired and the numbers from the pre-selected place values (e.g. tenths, hundredths, thousandths place values) are used as the random numbers in the game of chance (or game of skill with chance elements). Active traders worldwide need reliability, speed, and accuracy from their financial market data providers, so fortunately there is an abundance of financial real time data available all over the world.

Once the numbers are published and acquired from the pre-selected place values of the pre-selected financial data, these random numbers (or almost random numbers) can be converted using an algorithm into playing cards, dice, roulette pocket numbers, etc, as illustrated by a block 208. For converting into playing cards, shuffling algorithms are sometimes necessary even with the acquired random number. This can be done much in the same fashion that current random numbers are converted into cards in current games of chance, using algorithms such as the Fisher Yates algorithm.

In many card gambling games, either one or several decks of cards are shuffled. There are many algorithms that are used to shuffle a deck or decks of cards, such as the (e.g. Fisher-Yates shuffle and variants). The basic process of Fisher-Yates shuffling is similar to randomly picking numbered tickets out of a hat, or cards from a deck, one after another until there are no more left. What the specific algorithm provides is a way of doing this numerically in an efficient and rigorous manner that, properly done, guarantees an unbiased result. This is a very good example of how to shuffle an array. All these shuffling algorithms still require a random number generator. Without question, the randomness provided by the shuffle are of considerable commercial importance in online gambling, where the randomness of the shuffling of simulated cards is critical.

Often in games of chance, one may want randomness within a certain number of options, such as in roulette, one would want to have an equal chance of the ball landing in any of 38 potential pockets. In cards, one would want to have an equal chance of any of the 52 cards in a deck to be dealt, or in the case of an ongoing game, an equal chance of any of the remaining cards in the deck to be dealt. There are many currently algorithms that can do this. In the method of the current implementation, numbers from a place value range from 1 to 10. For example, if the S&P 500 Index value was 1300.56, the tenths digit would be “5” but the number could be a “0” up through and including “9”. So, the range for the random numbers generated would usually be different from the range of options in the game of chance (e.g. 52 cards, 38 roulette pockets). Once the random number is produced, currently available algorithms can convert those random numbers into playing cards, dice, etc fairly.

Even with the method of the current implementation, the random numbers provided may be biased. In this event, a simple algorithm such as John von Neumann's algorithm can fix simple bias and reduce correlation. Although the technique works no matter how the bits have been generated, it cannot assure randomness. What it can do is transform a biased random bit stream into an unbiased one. Again, the current method of providing random numbers may be used with any currently used algorithm.

In yet another implementation, to minimize the use of a complex algorithm, each card is assigned a number between 0.00 and 0.99, e.g., ace of diamonds would be 0.01 and two of diamonds would be 0.02, etc. Since there are 52 cards but 100 potential numbers with 2 significant digits that have a tenth number and a hundredth number, there will be occasions when the random number is 0.99 and there is no associated card with that number. Then, the player would wait another minute to receive his card. An alternative would be to have the same assigned numbers as above, but if the random numbers provided by the DJIA Index for example, did not match, the S&P 500 Index data would be used, as a backup. The legend should include these rules prior to play, to be fair. The chance 0.01 (ace of diamonds) showing up should be equal to the chance of 0.2 (two of diamonds) showing up and also equal to the chance of 0.99 showing up which would result in no card and a repeat of the cycle or using a second index for the random data.

In yet another implementation, each player could have a distinctly different assigning of numbers between 0.00 and 0.99 to each of the cards in the deck. This process of assigning numbers to cards could be randomized or selected by the house. The legend or key showing which playing card goes with which number would be visible prior to the actual card being dealt. In yet another version, the player could be allowed to match the numbers and the playing cards prior to the start of the game. The implementations of the last two paragraphs would be more suitable for an online game of blackjack with an infinite number of decks or an online roulette wheel, etc. In a game of cards that requires one deck and once a given card is used in a game and that card cannot be dealt again, an algorithm such as the Fisher Yates algorithm would be most efficient.

Continuing discussion of FIG. 2, once the algorithm is used to convert the random financial data, both the numbers used from the financial data and the associated algorithm result are posted so that it can be easily verified, as illustrated by a block 160. Verification of current online gaming software and web sites is difficult. In an online Internet version of the game Blackjack, a random card generator provides the cards. However, there may be suspicion on the part of the player that the “house” is not being fair and that the cards that are dealt the player are not truly random. There is currently no simple way to really determine that the card dealt is actually random. For instance, the player may win hands when the player makes small bets and then when the player makes larger bets, the house may win. In this scenario, the player may start to become suspicious that the cards are not truly random, even if in fact the cards are random.

With current blackjack web sites that use current random number generators, it would be very difficult to prove or verify that the random numbers were not tampered with or manipulated for a particular game. The random numbers could be falsified and it would be difficult for any “player” to ever prove in a court of law. The “house” could cheat and it would be very difficult to definitively prove that the “house” was cheating. However lack of ability to prove that the cards were manipulated is not proof that the cards were truthful. In the method of the current implementation, it would be easy to prove and substantiate that there was no manipulation of the random numbers that were generated by the method of the current implementation. In the method of this current implementation, the cards that are dealt (or dice, etc) are very close to random and yet can be completely verified almost immediately after the random numbers to be used (in card or dice conversion) are acquired from the financial data provider. Although not 100% random, a player can be assured that the “house” has no idea what cards will be dealt. Also, the player can verify after the cards are dealt that there was no “trickery” involved.

The method of the current implementation makes it easy to ensure that the random number generated and used in the game of chance has not been manipulated and that the random number was not known in advance by either party. The “player” can know with certainty that the random number that created the card used in the game was not “fixed” or manipulated. The “player” can corroborate the random number used in the game at the specific time of say, 11:32:00, within seconds or even years later very easily as long as he knows what time the game was played. With this method, it would be very easy to prove that neither party was aware what random number would be created at 11:32:00 prior to that time.

Verify means to confirm or substantiate. Verify means to establish the truth or accuracy. Verification of the random numbers used in the method described herein is made possible because the random numbers produced by the method of the current implementation is so readily available in real time all over the world. Although many current online gaming websites have independent third parties verify the legitimacy of their RNG's (random number generators), those verification activities may take place maybe once a year and verification would occur on systems provided by the website itself. Verification in real time of the random number generated for the card given the player is not possible with these systems. In the method of the current implementation, this real time verification of every card dealt is provided within seconds of the play action. This method provides at least almost random numbers; then complete confidence that it was impossible to manipulate this random number; and then allows easy verification of that almost random number. Verification of the random number (provided for the particular game) can be performed within seconds of the use of the random number by an independent party. The independent party verifying the random data only needs to know the particular index used and the time of data selection.

Many services and business offer “random numbers” for the purposes of lotteries, games of chance, games, and gambling. However, even if one is to believe that the service is truly random, it is hard to verify that number. The random number that is generated is not easily available everywhere inexpensively. For example, if the “house” generates a random number of 15 from Random.org at 11:32:00, it will be very difficult for the “player” to actually confirm that that was the number the “house” received from Random.org. In the method of the current implementation, an almost random number from the S&P 500 Index or other financial data is used to generate, say number 15, at 11:32:00. This number can be verified by almost anyone in real time if they have access to “real time quotes” from any number of commercially available Internet sites that provide real time stock data.

If the “house” were to use the services of random.org to obtain a random number of 15 for 11:32 am, for the “player” to verify that that was actually the case, the “player” would have to try to convince random.org to open its books and show the data, which might be very difficult to do, if at all possible, at the earliest days and possibly weeks after the game is played. It might require even a court order for a player to obtain that specific data from www.random.org. When using stock index data as described in this current implementation to provide the random number, the random number could be almost instantly and very easily verified without any red tape, without having to make any phone calls to private companies, without the aid of attorneys and without the need for a court order (all very expensive and time-consuming).

In a block 210 of FIG. 2, if it decided that there need be no more spins, cards, or dice (etc.), then the winner is calculated in a block 212 and the game is finished.

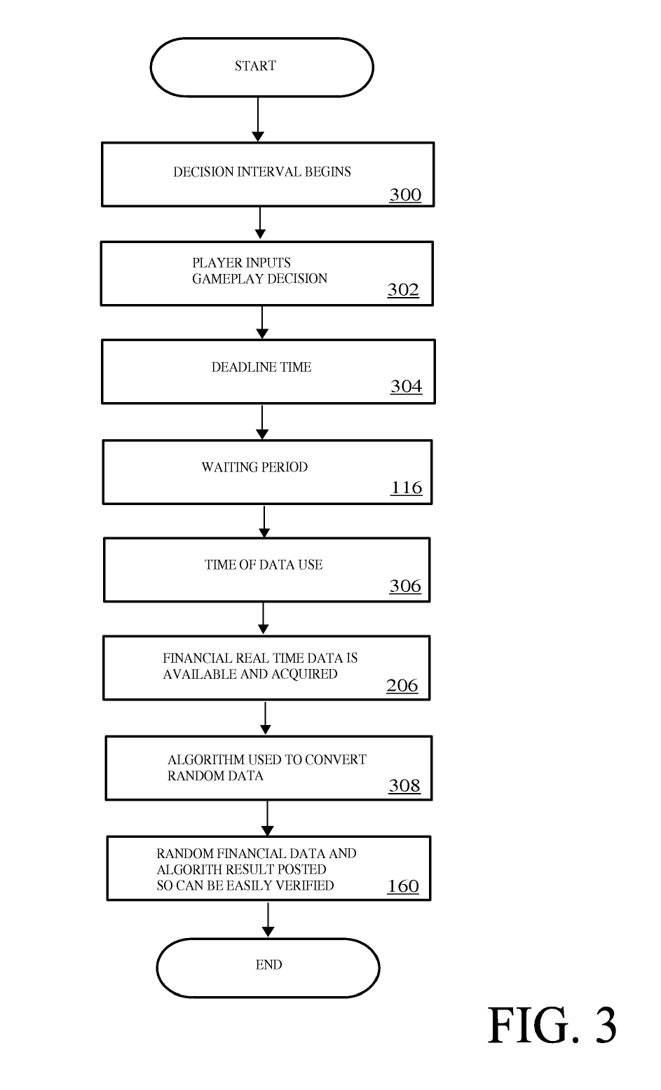

As illustrated in FIG. 3, definitions of certain boundaries regarding time are important to the proper functioning of the various implementations. Once a game begins, players typically have a time during which they can make a decision such as taking a card. This time has a beginning, illustrated by a block 300 and an end, which is referred to herein as the deadline time (DT), as illustrated in a block 304. Following the deadline time is the waiting period (WP), illustrated by block 116.

The Decision Interval (DI), shown in block 300, is the time period during which a player can make a decision to start the game, take a card, not take a card, place a bet, roll the dice, etc and then send the necessary signal/input to the website server (e.g., usually clicking on a button) regarding the player's decision. Typically, this would be a 15 second duration and start 15 seconds after the beginning of the new minute and extend to the DT, shown in block 304. In one implementation, there can be a diminishing bar displayed for the player that lasts the length of the DI during which the bar completely disappears, so the player is aware how much time he has to make a decision. There are many ways to visually show the passage of time to the player for this DI and for the WP and other time durations of the method of this implementation.

The player inputs the game-play decision of block 302 before the deadline time. In the event that a player chooses not to make a decision during the DI, the player may have the option to make a decision during the next DI or the following one. Each website server that uses the method of this current implementation may have their own rules and policies in regards to these issues, so the player is fully aware of the rules prior to playing the game. Any currently available algorithm can be used to convert the random data, as illustrated by a block 308. The random financial data and the algorithm result can be posted so can be easily verified, as illustrated by block 160.

The Deadline time (DT) of block 304 refers to the time after which the player can no longer make an input into the website server or take other actions to affect the website server that was permitted during the DI.

The Waiting Period (WP), shown in block 116, refers to the length of time between DT and the Time of Data Use (TODU—explained below) shown in block 3060. Because of the nature of electronic communications between a players computer, Internet connection speed, and website server processing, none of these numbers would be exactly precise. For example, suppose a decision by the player to take a card was received 5 seconds after the DT by the website server. The server would reject the decision and inform the player of such. There would still be at least 15 seconds prior to the TODU and it would be very difficult to argue that the website server somehow knew at the time the server sent the rejection to the player knowing the website would have an advantage.

Speed of receiving financial data is important. Because there are many financial market data providers all over the world now, accessibility of financial data is much easier today. Low latency is a frequent topic among capital markets because algorithmic trading requires firms to react to market events quicker than the competition to increase profitability of trades. Many companies that deliver market data are using the words “ultra low latency” to describe latencies under 1 millisecond. Market data that is just a few hundred milliseconds tardier is thought to cause slower trading decisions and lost opportunities in the world of automatic trading. This difference is important to the method of this implementation because the difference between the fastest delivery of market data and the average delivery of real market data is within a few hundred milliseconds but very easily within 2 seconds. The average player can be reasonably sure that 30 seconds prior to, for example, 11:00:00, no one will know the tenths and hundredths place values of the S&P 500 Index value that will be disseminated at 11:00:00. In this scenario, latency is much less of an issue than in stock trading, because the decision deadline occurred 30 seconds prior to 11:00:00. So, if the S&P 500 Index value that is published at 11:00:00 is acquired at 11:00:08, it will not change the decision that occurred before the deadline and it will not change the result. So, latency of a few seconds is unimportant to the method of this implementation, in stark contrast to the world of automatic trading. For example, waiting period between the time of placing a bet until financial data is obtained is approximately in the range of twenty seconds to 120 seconds. This waiting period is long enough to insure that financial data is unknown to all parties at the time the bet is placed, but short enough to feel responsive to a player.

Time of Data Use (TODU), illustrated in block 306, refers to the time that real financial data is published. This TODU would normally be the data provided by the various real time financial data providers; each data provider may have slightly different numbers for various stock financial data but a given online game website would use a single provider and the financial data provider would be consistent in their delivery of this data. Also, index data is usually prepared by one company and then disseminated and so highly unlikely that different financial providers would have slightly different numbers for the exact same time for index data.

The S&P 500 index value is updated every 15 seconds during trading sessions and is disseminated by Reuters American, Inc. As an example, the S&P 500 Index may be 1300.12 at 11:00 am and zero seconds, or 11:00:00 (ISO 8601 notation). Since the S&P 500 index is updated every 15 seconds, when we refer to the 11:00 am and zero seconds (11:00:00), we are referring to the S&P 500 index number during the time period 11:00:00 to 11:00:15. It may be 1301.49 at 11:00:15 to 11:00:30. No one will know, 30 seconds prior to 11:00:00 am, what the tenths number and hundredths number of the S&P 500 Index will be at exactly 11:00:00 am if the market is open and being traded. Time notations will use the International Standard ISO 8601 to help avoid confusion. ISO 8601 does not specify, whether its notations specify a point in time or a time period. This means for example that ISO 8601 does not define whether 09:00 refers to the exact end of the ninth hour of the day or the period from 09:00 to 09:01. In the method of the current implementation, both parties need to be aware of the time notation and agree on its definition before the game is played. For example, the S&P 500 index is updated every 15 seconds and when we refer to the 11:00:00, we are referring to the S&P 500 index number disseminated during the time period 11:00:00 to 11:00:15, which will be the TODU in this particular example.

Time when Data is Available 206 (DIA) would be very similar to TODU but due to latency of different providers, could vary by up to a few seconds (highly unlikely), assuming the house uses a provider of real time financial data with low latency.

Some players may believe that certain financial data could be known by large financial institutions and that the tenths and hundredths data from the data at TODU could be known at the Deadline Time (DT). Although, to know this data even 5 seconds in advance is probably impossible, the waiting period (WP) duration can always be increased and can even be placed a day in advance. However, what player would want to receive one card every 24 hours? It would be extremely hard to argue that even the largest financial institutions would be able to predict the tenths and hundredths decimal place numbers of the S&P 500 Index even 5 seconds before. To be able to predict those same numbers (when the market is open and moving) 30 seconds in advance would be virtually impossible. If there were individuals or financial institutions that could predict those tenths and hundredths place value numbers 30 seconds prior to the TODU, they could make millions of dollars every minute in the market itself. With the system and method of the current implementation, the player can be assured that no one will know what the tenths and hundredths digit numbers of the S&P 500 Index will be, seconds prior to the TODU.

In this method of using random numbers derived from market data, even if someone receives market data 2 seconds in advance of everyone else, it is irrelevant because the rules of the game require the decision to take the card or not (or other decision based on the random number that will come out) at least 5 seconds before the TODU but usually 30 seconds before TODU.

Certain financial indices change more often in certain incremental amounts (e.g. by 0.10) and so the smallest value digit may not be the most random number. Once it is determined which financial index or value is chosen as the random number generator, the strength of the randomness of the number can be tested by current random number generators. There will be some indices that consistently perform more randomly than others and so will have higher value for the method of the implementation described herein.

As another example, if the S&P 500 Index data at 11:31:00 306 is 13,153.67, the “6” or the “7” or both could be used as the random number and converted into a card such as “two of hearts” or “King of Spades”, so the “house” and “player” can play their game. The player has a certain amount of time to make a decision to take a card. The player must make his decision by 11:30:30 304 (although this gives 30 seconds for the decision to be registered this duration may be shorter or longer as long as there is sufficient time to make sure the players' decision is registered and the “house” is certain that the data is not available to either party. Once the player makes the decision and inputs it, there is a small waiting period 116 before the electronic “card” arrives. Both the player and the house can be fairly certain that no one knows what random number will be published at 11:31:00. However, both the player and house can be fairly certain that many other independent parties can verify the exact same random number for 11:31:00. Since the S&P 500 index number is formed from 500 companies, being able to predictably manipulate the smallest digits of the S&P 500 Index in a predictable fashion would be next to impossible. So, at 11:30:00, neither the website operator, the player, or anyone else including the publisher of the S&P 500 index, would know what the last two digits of the S&P 500 Index data will be at exactly 11:31:00.

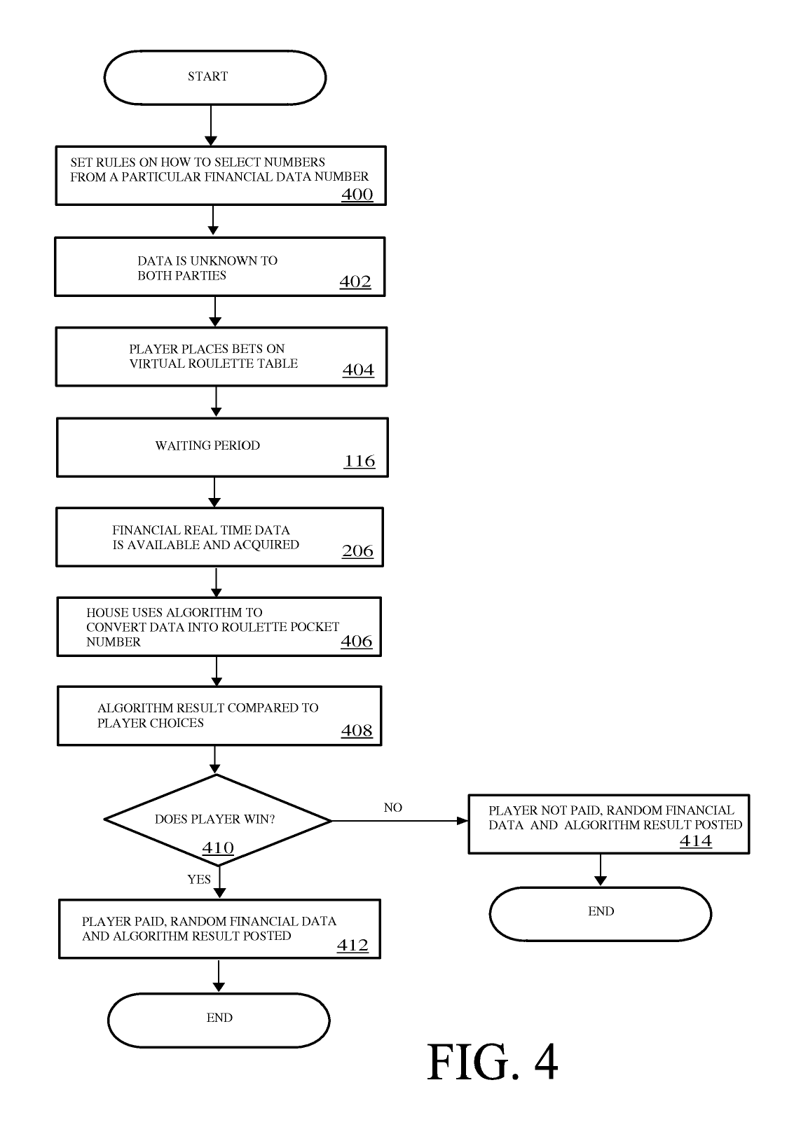

FIG. 4 illustrates an implementation for online roulette. The exact financial index from which the random number will be selected is known prior to the game starting, as illustrated by a block 400. An algorithm can be used to convert the random two-digit number into a roulette number (any number of currently available algorithms can be used), or simply, the roulette numbers 1 thru 36 and “zero” and “double zero” can each be associated with a number. Since there are 38 pockets in roulette but a hundred numbers (in increments of 0.01) between 0.00 and 0.99 (the tenths and hundredths place of the given index selected), each pocket can be assigned two numbers. For example, “zero” can be assigned 0.00 and 0.01, and “double zero” assigned 0.02 and 0.03, and “red 1” assigned 0.04 and 0.05, etc. That would still leave approximately 24 numbers from the random number range (between 0.00 and 0.99) that are not assigned a pocket. The legend showing the random number assignation to each roulette pocket can be made available at the beginning of the game, on a separate page, on the same webpage, or continuously during play. A rule can be devised such that if no numbers hit, it would be similar to the ball spinning out and the “wheel” is spun again (another random number chosen at a later time). The chances of any of the 38 pockets being chosen is statistically equal and if none of the pockets are chosen and the “wheel” spun again, the same odds are in place and the chances of any of the 38 pockets being chosen is still equal.

To continue the online roulette example, the player would place bets as desired, as illustrated by a block 404. There would be a short period of time during which the player can ask for a “spin”. Then there would be a waiting period 116 during which neither the house nor the player has any idea what number will be selected. There may be (on the display) a simulation of a ball rolling around a roulette wheel, which is also spinning. Before this waiting period, the random data has not been published and is unknown to both parties, as illustrated by a block 402. The index and time that determines the random number to be used is set prior to the game and instructions on how to determine the random number is also placed in the rules of the game, as illustrated by block 400. For example, the Index to be used is the DJIA and the first digit of the random number will be the DJIA Index tenths digit value at the start of each minute and the second digit of the random number will be the DJIA Index hundredths digit value at the start of each minute. Once the random number is obtained from the set index at the set time 206, it is converted into the roulette pocket number, illustrated by a block 406 and it is determined if the player has won, as illustrated by a block 410. The past “spins” and the results along with the random number associated with that particular result, the index from which the random number was derived and the time of the data can be posted, as illustrated by a block 412. The random financial data and algorithm is posted even if the player does not win, as illustrated by a block 414. The player can easily verify the accuracy of this information by a third party within seconds of the random number selection. The system and method of this implementation is the most completely transparent method of online gaming, because every hand or spin can be verified within minutes and many times within seconds. Current online gaming sites try to exercise transparency on their random generators and software by employing an auditing firm to check the authenticity of their claims. Often this is done at most once a year. The player would still have to believe the auditing firm. Compare that to the current implementation where accuracy and absence of manipulation of the random numbers used can be verified almost immediately after each game or even during the game, using outside sources at a low cost and where the player can determine with their own common sense whether play is fair and honest.

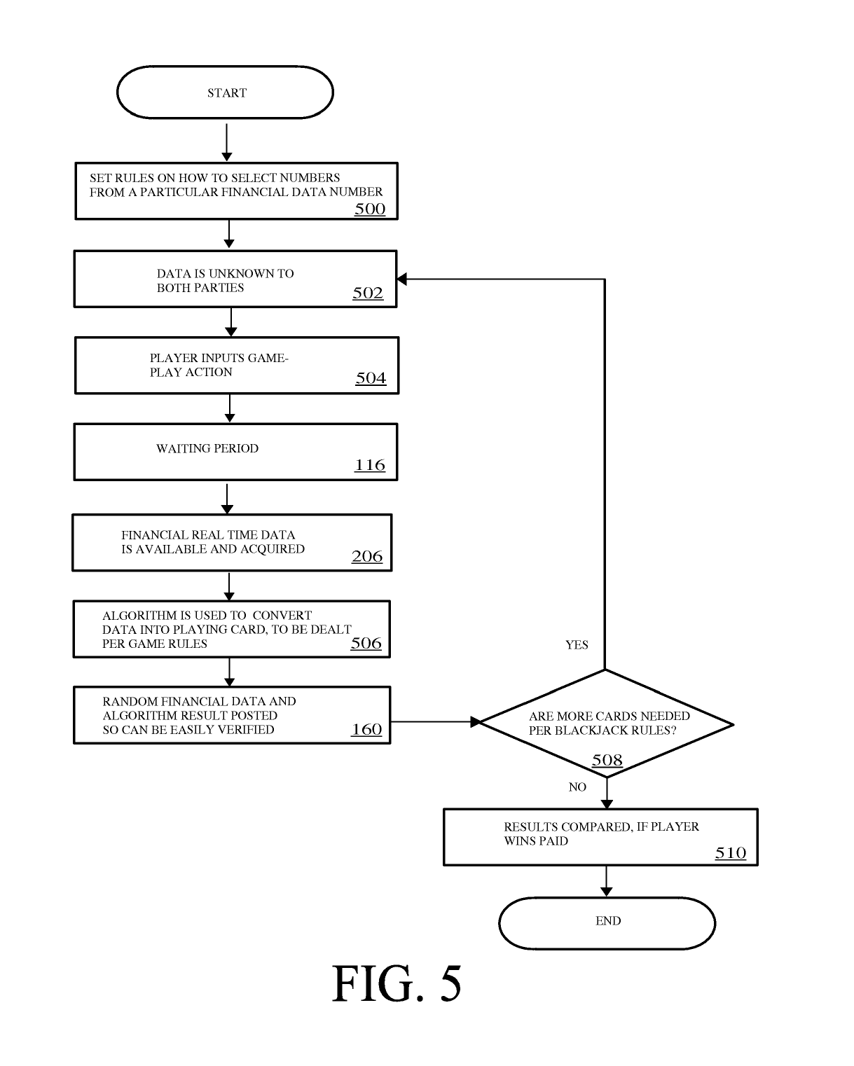

FIG. 5 illustrates an implementation for online blackjack. The exact financial index from which the random number will be selected and the future time of data is selected prior to the start of the game, as illustrated by a block 500. The particular numbers that will be used from the financial index at a future time is unknown to both parties, as illustrated by a block 502. An algorithm can be used to convert the random two-digit number into a card (any currently used algorithms that use random numbers and convert those random numbers into playing cards may be used), as illustrated by a block 506.

In some blackjack games, players prefer a “single deck” of cards. In these types of situations, many of the currently available algorithms may be used to provide this “computerized shuffling” of cards. Shuffling is a procedure that is used to make a deck of playing cards random and so provide an element of chance in games involving cards. Shuffling is often followed by a cut to help confirm that the shuffler has not manipulated the potential outcome. Shuffling algorithms are used in current online games involving cards. A computer is able to generate a random permutation of cards. The Fisher-Yates shuffle is simple and efficient and is a computer algorithm capable of providing a very good computerized shuffle for these online games. The Fisher-Yates shuffle still requires a random number to be generated.

A very simple algorithm (if an “infinite” number of decks in dealing cards for blackjack is acceptable) would be as follows; there are 13 cards in each suit and 4 suits so a total of 52 cards. Each of the 4 suits would be associated with a random number from a given Index A (for illustration purposes). So, “hearts” would be assigned 0.01 to 0.25, and “spades” would be assigned 0.26 to 0.50, and “diamonds” would be assigned 0.51 to 0.75, and finally “clubs” would be assigned 0.76 to 0.00. So, at the designated time, if Index A is 1324.56, then 0.56 would be the random number used and it would correspond to “diamonds”. The suit would then be diamonds. A second Index B (for illustration purposes) is pre-selected to provide the random number that will then be assigned for the cards “Ace” through “King”. Since there are 13 cards but the random range is 0.00 thru 0.99 (100 numbers in the range), each card is assigned 7 numbers and there are 9 remaining numbers. So, “ace” would be assigned 0.01 to 0.07, the “two” card would be assigned 0.08 to 0.14, etc. In this example, if Index B at the designated time is 1445.01, then the random number to be used would be “0.01” and it would correspond to an “ace”. In the event the random number is 0.99 and 0.99 does not correspond to a card, then it would be re-dealt.

The legend or key showing the random number assignation to each card and suit will be available at the beginning of the game, on a separate page, on the same webpage, or continuously during play. A rule can be devised such that if no cards are chosen, the tenths and hundredths place of a third pre-selected index is used, and if no cards are chosen even with the third index, a fourth index is immediately used, and so on.

To continue the online blackjack example, the player would place bets as desired, as illustrated by a block 504. There would be a short period of time during which the player can ask for a “card”. Then there would be a waiting period 116 during which neither the house nor the player has any idea what card will be selected. Prior to the waiting period, the random data will be unknown to both parties, without question, as illustrated by a block 502. The index and time that determines the random number to be used is set prior to the game and instructions on how to determine the random number is also placed in the rules of the game. For example, the Index to be used might be the DJIA and the first digit of the random number will be the DJIA Index tenths digit value at the start of each minute and the second digit of the random number will be the DJIA Index hundredths digit value at the start of each minute. Once the random number is obtained from the set index at the set time, illustrated by block 206, it is converted into the card as described above, as illustrated by block 506 and it is determined if the player has won. The past “cards” and the results along with the random number associated with that particular result, the index from which the random number was derived and the time of the data can be posted, as illustrated by block 160. The player can easily verify the accuracy of this information by a third party within seconds of the random number selection. As more cards are needed according to the rules of the game, this cycle can be repeated, as illustrated by a block 508. At the conclusion, the cards are compared and the player paid if he has won, as illustrated by a block 510.

The game of blackjack usually requires a face down card for the house. In the method of the current implementation, even if a card is given face down, because the card is derived from index data that can then be verified and “known” by the player, a face down card would be meaningless and a serious disadvantage to the house. So, the game would be adjusted so that the “house” receives the second card after the player has completed his/her decisions.

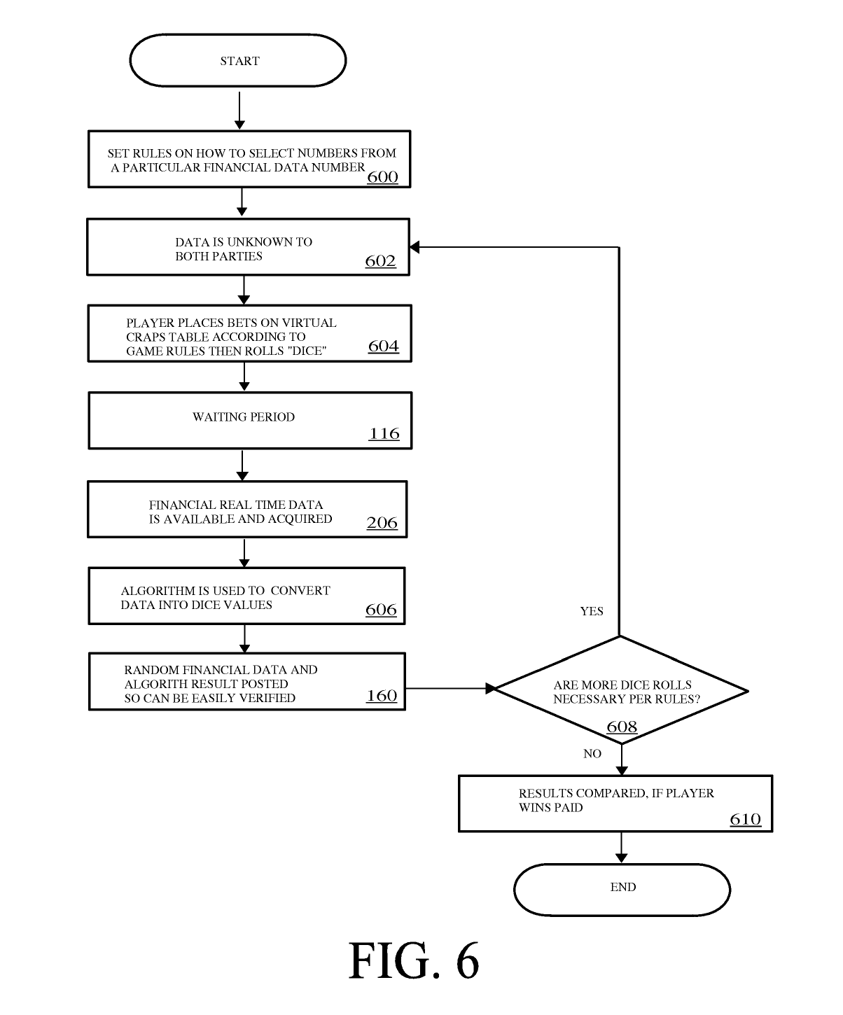

FIG. 6 illustrates implementation for the game of craps. The exact financial index from which the random number will be selected is known prior to the game starting, as illustrated by a block 600. In a block 602, data is unknown to both parties. Other rules for Craps are also clearly laid out. An algorithm can be used to convert the random two-digit number into dice values (1 dot through 8 dots) (any number of currently available algorithms can be used), as illustrated by a block 606.

Another simple method to convert the random numbers into random dice is as follows. Since there are 8 possible dice results from a roll (1 thru 8 dots) and there are two dice, a given Index A (for illustration purposes) is selected and the tenths digit and hundredths digits are used. There are a 100 possible random numbers from 0.00 to 0.99 going up by 0.01 steps. Since there are 8 combinations, each is assigned 12 numbers from the range 0.00 to 0.99. So, a dice with “one dot” would be represented by 0.01 to 0.12. A dice with “two dots” would be represented by 0.13 to 0.24 and so on. There will be 4 possible random numbers between 0.00 to 0.99 that do not represent any dice.

The second dice would have the same representations but by a given Index B (for illustration purposes) which would also have a 100 possible random numbers from 0.00 to 0.99 when increasing by 0.01 steps from 0.00. There will also be 4 possible random numbers that do not represent dice here also.

If either Index ends up at the pre-determined time to select a random number that is not assigned a dice value, then both dice would be “rolled” again, or however the rules would dictate.

The legend or key showing the random number assignation to each dice value can be made available at the beginning of the game, on a separate page, on the same webpage, or continuously during play. The chances of any of the 8 values for each dice being chosen is statistically equal and if none of the dice are chosen and the dice “rolled” again, the same odds are in place and the chances of any of the 8 values for each dice being chosen is still equal.

To continue the online craps example, the player would place bets as desired, as illustrated by a block 604. There would be a short period of time during which the player can “roll” the dice. Then there would be a waiting period 116 during which neither the house nor the player has any idea what random number will be selected. During this waiting period, there may be (on the display), a simulation of dice that are rolling around on the craps table. The index and time that determines the random number to be used is set prior to the game and instructions on how to determine the random number is also placed in the rules of the game, as illustrated by a block 600. As index real time data becomes available, it is acquired, as illustrated by block 206. If there are more dice rolls/throws necessary, per game rules, then the process is repeated, as illustrated by a block 608. The results are compared and if the player wins, he is paid, as illustrated by a block 610. The past “rolls” and the results along with the random number associated with that particular result, the index from which the random number was derived and the time of the data, can be posted, as illustrated by block 160. The player can easily verify the accuracy of this information by a third party within seconds of the random number selection.

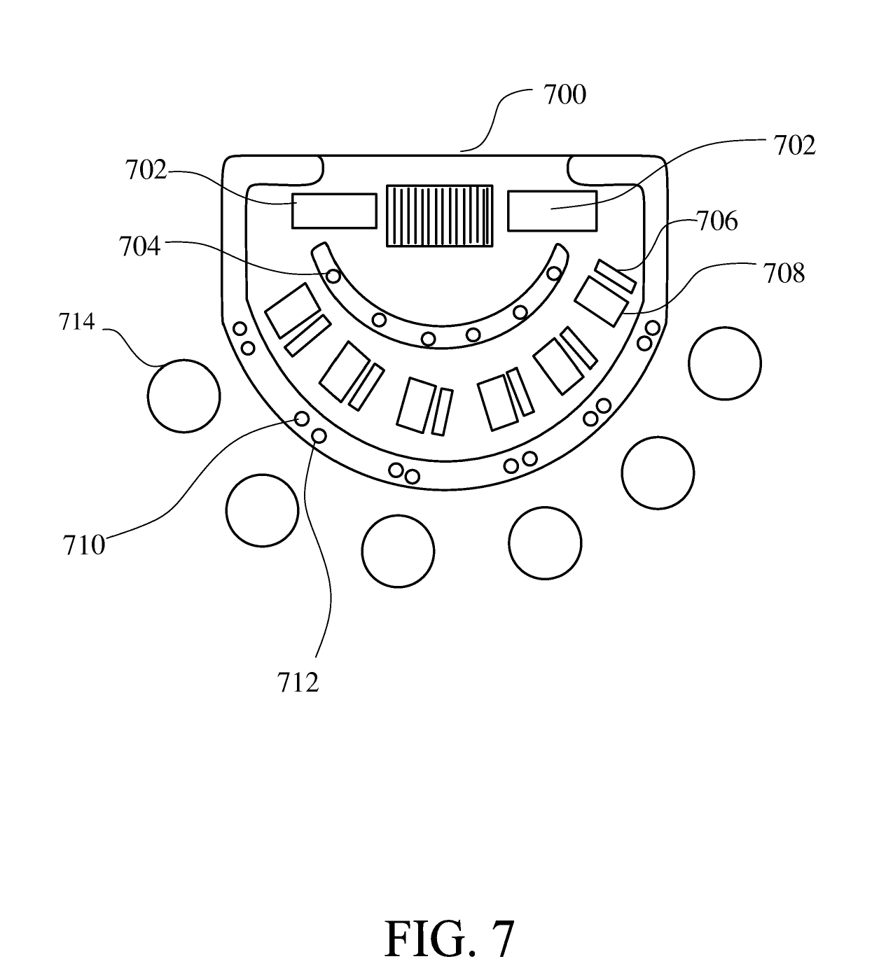

FIG. 7 shows an alternative implementation of the implementation as a Blackjack table 700, but could also be a Roulette wheel or craps table. It is a typical Blackjack table except cards are not dealt out by the dealer, but by the random number producer of the current implementation and displayed by a small video screen 708 on the table 700. Video screen 708 serves as a display that shows a selected game value that is used to determine whether the player is a winner or a loser. Historical numbers generated by the method of this implementation and the associated algorithm result (card) is displayed on a display 706, next to video screen 708 where the cards are displayed. Video screen 706 serves as a display of an historical value for a financial asset used to generate the selected game value. The historical value is generated after the input receives the game input from the player and before the display displays the selected game value. The historical value is generated by a financial exchange independent of the gaming table. The historical value generated by the financial exchange is verifiable by an internet query to an information server. For blackjack, the selected game value is a playing card. For Roulette, the selected game value is a value for a game of Roulette including all the information for a number and color, etc. For craps, the selected game value is a value for a pair of dice.

Players can communicate their game-action decisions via buttons 710 and 712 located next to their chairs 714. Buttons 710 and 712 serve as an input device that receives game input from a player. The particular rules of this Blackjack game, what financial data is used to obtain the random number, what times are used and other pertinent information can also be displayed on displays 702. There may be lights 704 or other method of informing player when he can press the buttons 710 and 712. Lights 704 serve as indicator that indicates to the player when the input device is ready to receive the game input. The lights 704 may be green when he can make a game-play decision. The lights may turn yellow when he is almost out of time and be red to signal that he cannot push any buttons or otherwise relay his decisions. In this fashion, the method and system of this implementation can be used at actual physical locations wherein the player is not in a remote location.

The method of this implementation can be used to generate random numbers for games of chance at actual physical establishments such as Las Vegas, Atlantic City, and Indian Reservation Casinos throughout the U.S, and can include but would not be limited to Blackjack, Poker, Craps, Roulette, Baccarat, Pai-Gow and even slot machines. At physical locations, instead of having a dealer deal cards, a module or table 700 with video screens could be present that provides the cards based on the random number generator of the current implementation. This would prevent concerns of players marking cards that can give a player an advantage, or other similar issues with card tampering.

For all the above described implementations, receiving financial data from the data providers can be accomplished in several ways. For example, an application program interface (API) can be used. An API is a set of routines, protocols, and tools for building software applications. The API specifies how software components should interact and are used when programming graphical user interface (GUI) components. There are several types of APIs for operations systems, applications, or websites. The API is software code written as a series of XML messages. An API specifies how software components should interact with each other.

XML (Extensible Markup Language) is a markup language that defines a set of rules for encoding documents in a format that is both human-readable and machine-readable. XML has come into common use for the interchange of data over the internet and can be used to request and receive financial data from the data providers.

There are XML messages that correspond with each element required in obtaining data from the financial data provider. Those elements include but are not limited to time, the data provider's name and contact information, the time of request, the information transmitted, the time the information is provided, et cetera. All these elements could be maintained on the gaming server and provided to the player after each play (or some elements could even be provided during play) or it could be maintained on the player's computer (or smart phone).

WSDL (Web Services Description Language) is another method that can be used to communicate with the financial data providers. WSDL is an XML format for describing network services as a set of endpoints operating on messages containing either document-oriented or procedure-oriented information. The operations and messages are described abstractly, and then bound to a concrete network protocol and message format to define an endpoint.

Data can also be obtained from the financial data providers using push services. Push, or server push, describes a style of Internet-based communication where the request for a given transaction is initiated by the publisher or central server. It is contrasted with pull, where the request for the transmission of information is initiated by the receiver or client. Push services are often based on information preferences expressed in advance. This is called a publish/subscribe model. A client “subscribes” to various information “channels” provided by a server; whenever new content is available on one of those channels, the server pushes that information out to the client.

For example, constant confirmation and verification of data sent/received can be communicated via the internet to the player's computer or player's mobile devices. This flow of communication of information to the player's computer can include a complete or partial log of data received from the financial data provider to the website server.

A complete log of the particular game being played (e.g., the particular rules of the game, the player's actions, the website server communication with the financial data provider and the website server communication of information/data to the player) can also be provided to the player as the information becomes available. This could be presented on the screen constantly, with the most current information replacing streaming across the display, or pushing the older information up or down on the display as newer information comes in.

The most important information would of course be the actual random number (e.g. S&P Index numbers) and this particular information could be presented on the player's display (as soon as available) in a similar design that past wins are displayed in Las Vegas in a real game of Roulette with a real table that has a vertically standing rectangular shaped electronic display that shows winning numbers in red or black or green. In such an implementation, the historical wins can also be displayed in a vertically positioned rectangular-shaped box containing data with the actual S&P index data that was the winning number (with the font of the numbers displayed also in red or green or black depending on the correlation with the wheel and the particular rules/legend of the game). This would be another way of displaying the log of historical wins.

In another implementation, a player can actually choose the types of log information he wants displayed as he plays his particular game and in what manner he wants the log information displayed. The player can choose from pre-packaged options that could include simple, basic, extensive, and complete or the player could customize the log information he desires. A computer receives a selection from the player that indicates a level of detail to be displayed pertaining to historical values to be used for generating game values. An amount of detail displayed for the historical value is based on the selection received from the player.

A “Simple” option for data that the player wants displayed might include more limited information such as the actual random number obtained from the financial data provider and waiting period and deadline time. A “Complete” option for data that the player wants displayed would include much more data and include information such as the game played, the rules for the game, the time that each play is started, the particular index that is being used for the game, the deadline time, the waiting period time with a visual way of showing time elapsing (e.g. progress bar, stopwatch), time of data use, time the website server received information from the financial data provider, etc. The “complete” option can include any data or information discussed in this patent disclosure. Even in the event that a player opts for a “simple” option for data display during the game, the player would always have the option to obtain a text file of all the above logged information in the “Complete” option. This log of communications and information can be made available on the player's display or sent to the player via email or text.

Any description of an implementation herein also includes computer hardware, other hardware and software that already exist in the prior art and may be necessary for the operation of the particular implementation. Each of the above-described implementations and variations thereof of the current implementation provides a system and method for providing almost random or random number that are almost instantly verifiable for games of chance, thereby reducing the concern of rigging and cheating. The present implementation has been described in terms of various implementations solely for the purpose of illustration. Persons skilled in the art will recognize from the description above that the implementation is not limited to the implementations described.

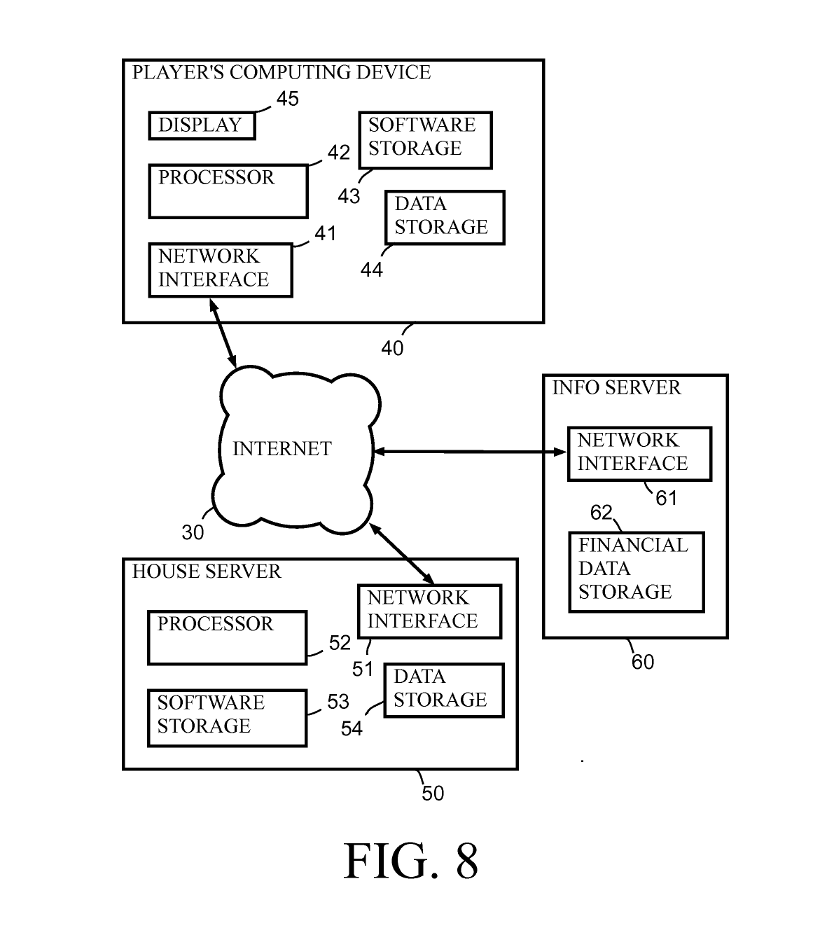

For example, FIG. 8 shows an implementation where a player's computing device 40 includes a display 45, a processor 42, hardware storage for software 43, hardware storage for data 44 and a network interface 41. A house server 50 includes a processor 52, hardware storage for software 53, hardware storage for financial data 62 and a network interface 61. For example, information server 60 is a source of financial information or other information used to calculate random numbers. For gaming table such as blackjack table 700, the function of player's computing device 40 and house server 50 may be combined into a single computing device within the gaming table. Also, while communication is shown through internet 30, alternative networks may be used for communication.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

What is claimed is:

1. A gaming table comprising:
an input device that receives game input from a player;
an indicator that indicates to the player when the input device is ready to receive the game input;
a display that shows a selected game value that is used to determine whether the player is a winner or a loser; and,
a display of an historical value for a financial asset used to generate the selected game value, the historical value being generated after the input device receives the game input from the player and before the display displays the selected game value, the historical value being generated by a financial exchange independent of the gaming table, wherein the historical value generated by the financial exchange is verifiable by an internet query to an information server.

2. A gaming table as in claim 1 wherein the selected game value is a playing card.

3. A gaming table as in claim 1 wherein the selected game value is a value for a game of Roulette.

4. A gaming table as in claim 1 wherein the selected game value is a value for a pair of dice.

5. A gaming table as in claim 1 wherein the financial asset is one of the following:
a share of stock;
a share of exchange traded fund;
a specified amount of a commodity.

6. A gaming table as in claim 1 wherein the input device additionally receives a selection from the player that indicates which financial asset will be used to generate the selected game value.

7. A gaming table as in claim 1 wherein the input device additionally receives a selection from the player that indicates a level of detail to be displayed pertaining to historical values to be used for generating game values wherein an amount of detail displayed for the historical value is based on the selection received from the player.

8. A computer implemented method for generating values used in games of chance, comprising:
receiving a selection from a player that indicates a level of detail to be displayed pertaining to historical values to be used for generating game values;
generating a selected game value that is used to determine whether the player is a winner or a loser; and,
displaying an historical value for a financial asset used to generate the selected game value, the historical value being generated after the input receives the game input from the player and before the display displays the selected game value; the historical value being generated by a financial exchange independent of the gaming table, wherein the historical value generated by the financial exchange being verifiable by an internet query to an information server;
wherein an amount of detail displayed for the historical value is based on the selection received from the player.

9. A computer implemented method as in claim 8 additionally comprising:
receiving a selection from the player that indicates which financial asset will be used to generate the selected game value.

10. A computer implemented method as in claim 8 wherein the selected game value identifies a particular playing card.

11. A computer implemented method as in claim 8 wherein the selected game value is a value for a game of Roulette.

12. A computer implemented method as in claim 8 wherein the selected game value is a value for a roll of dice.

13. A computer implemented method as in claim 8 wherein the financial asset is one of the following:
a share of stock;
a share of exchange traded fund;
a specified amount of a commodity.

14. A computer implemented method for generating values used in games of chance, comprising:
receiving a selection from the player that indicates which financial asset will be used to generate selected game values that are used in games of chance;
generating a selected game value that is used to determine whether the player is a winner or a loser; and,
displaying an historical value for the financial asset used to generate the selected game value, the historical value being generated after the input receives the game input from the player and before the display displays the selected game value; the historical value being generated by a financial exchange independent of the gaming table, wherein the historical value generated by the financial exchange being verifiable by an internet query to an information server.

15. A computer implemented method as in claim 14 additionally comprising:
receiving a selection from the player that indicates a level of detail to be displayed pertaining to historical values to be used for generating game values.

16. A computer implemented method as in claim 14 wherein the selected game value identifies a particular playing card.

17. A computer implemented method as in claim 14 wherein the selected game value is a value for a game of Roulette.

18. A computer implemented method as in claim 14 wherein the selected game value is a value for a roll of dice.

19. A computer implemented method as in claim 14 wherein the financial asset is one of the following:
a share of stock;
a share of exchange traded fund;
a specified amount of a commodity.
